(19) United States
(12) Patent Application Publication
(10) Pub. No.: US 2015/0099035 A1
(43) Pub. Date: Apr. 9, 2015

(54) OMEGA-3 FATTY ACID ENHANCED DDGS FOR AQUACULTURE FEEDS

(71) Applicant: Prairie AquaTech, Brookings, SD (US)

(72) Inventors: Jason Bootsma, Sioux Falls, SD (US); William Gibbons, Brookings, SD (US); Michael Rinehart, Dell Rapids, SD (US); Liyan Chen, Brookings, SD (US)

(73) Assignee: PRAIRIE AQUATECH, Brookings, SD (US)

(21) Appl. No.: 14/506,385

(22) Filed: Oct. 3, 2014

Related U.S. Application Data
(60) Provisional application No. 61/886,592, filed on Oct. 3, 2013.

(51) Int. Cl. A23K 1/00; A23K 1/16

(52) U.S. Cl. CPC A23K 1/007; A23K 1/1631; A23K 1/164
USPC 426/28; 426/53; 426/656

(57) ABSTRACT

The present invention describes fermentation methods for producing animal feeds enriched with omega-3 fatty acids from cellulosic feedstock.

### CROSS REFERENCE TO RELATED APPLICATION

This application claims benefit under 35 U.S.C. §119(e) to U.S. Provisional Application No. 61/886,592, filed Oct. 3, 2013, which is incorporated by reference herein in its entirety.

This work was made with Governmental support from USDA, National Institute of Food and Agriculture, under contract No. 2014-33610-21950. The Government has certain rights in this invention.

### BACKGROUND OF THE INVENTION

1. Field of the Invention

The present invention relates generally to fermentation processes, and specifically to fermentation processes to produce protein concentrates and lipids containing omega-3 fatty acids, products made therefrom and use of such products in the formulation of nutrient feeds.

2. Background Information

Both fish oil and fish meal are key ingredients in aquaculture feeds, but unfortunately their production from wild-caught fishes cannot meet world demand. The limited availability and high prices of fish oil and meal have increased aquaculture feed costs, reducing profitability, and thus, inhibit expansion of the U.S. aquaculture industry.

Each year over the past 20, wild fish harvest has decreased by −0.7 metric tons per year, and the FAO recently reported that 53% of the world's wild fish stocks are now fully exploited, where 32% are over-exploited, depleted or recovering from depletion. This, coupled with rising demand for fish and shellfish products, has caused aquaculture to grow at a consistent rate of 9% annually over the past decade. This has created a similar increase in demand for fish meal and fish oil, the primary ingredients in aquaculture and early-life stages livestock feeds. Unfortunately, wild harvest of species used for fish meal and fish oil has been similarly exploited, resulting in price spikes and shortages for both. Currently 70-80% of fish meal and 80-90% of fish oil are used for aquaculture, resulting in competition for livestock and human food uses, respectively. Prices of fish meal and fish oil have more than doubled in the last five years. High prices are driving up production costs and thereby limiting continued expansion of aquaculture.

In aquaculture diets (particular carnivorous species) fish meal supplies much of the required 40-50% protein content, while fish oil supplies the required 2-4% omega-3 fatty acid levels. A variety of plant-based protein sources, such as soybean meal and distiller's grains have been used to replace up to 30% of fish meal in aquaculture diets. Unfortunately, anti-nutritional or non-digestible components in these feedstuffs limit inclusion rates.

Replacement of fish oils remains a challenge. Trials using flax-seed oil (rich in omega-3 fatty acids) as an alternative to fish oil have had limited success because flax seed oil does not contain DHA or EPA, which are specific omega-3 fatty acids required by fish. Moreover, flax seed oil contains increased levels of omega-6 fatty acids, which actually reduce the effectiveness of omega-3 fatty acids in non-salmonids. Consequently, fish fed with flax seed oil have lower levels of omega-3 fatty acids in their tissues. Algal oil represents a separate alternative.

Unfortunately, the low volumetric productivity and yield of these systems, combined with expensive oil recovery and dewatering steps, have resulted in prohibitively high costs for feed applications, such that algal oil is only feasible for the high value human consumption market.

Therefore, there remains a need for replacement of omega-3 fatty acids sources derived from fish oils.

### SUMMARY OF THE INVENTION

The present invention describes fermentation methods that result in non-animal protein concentrates enriched with omega-3 fatty acids, which concentrates may be used to prepare feeds for animals and fish.

In embodiments, a method of increasing the omega-3 fatty acid content of a non-animal based protein concentrate is disclosed including optionally pre-treating a first cellulosic feedstock, mixing the cellulosic feedstock with water and feeding the resulting mixture into a reactor; sterilizing the mixture; cooling the sterilized mixture and adding a consortium of saccharifying enzymes under conditions to form a hydrosylate; cooling the hydrosylate and inoculating the hydrosylate with a biocatalyst that metabolizes sugars in the hydrosylate; incubating the inoculated hydrosylate; and optionally adding a second cellulosic feedstock to the inoculated hydrosylate and continuing incubation until the sugars are depleted to form a slurry, where the slurry includes protein, the biocatalyst and omega-3 fatty acids. In a related aspect, the a second cellulosic feedstock is added after 48 hours incubation.

In one aspect, the first cellulosic feedstock is DDGS. In a related aspect, the second cellulosic feedstock is CCS.

In another aspect, the protein content is between about 30 to about 50% on a dry matter basis.

In one aspect, the omega-3 fatty acid is DHA. In a related aspect, the DHA content is about 0.5 to about 0.7% on a dry matter basis. In a further related aspect, the biocatalyst is S. limacinum.

In another embodiment, a method of increasing the omega-3 fatty acid content of a non-animal based protein concentrate is disclosed including mixing a cellulosic feedstock with water and feeding the resulting mixture into a reactor; sterilizing the mixture; cooling the sterilized mixture and adding a consortium of saccharifying enzymes under conditions to form a hydrosylate; cooling the hydrosylate and inoculating the hydrosylate with a biocatalyst that metabolizes sugars in the hydrosylate; incubating the inoculated hydrosylate; and optionally adding a second cellulosic feedstock to the inoculated hydrosylate and continuing incubation until the sugars are depleted to form a slurry, where the slurry comprises protein, the biocatalyst and omega-3 fatty acids. In a related aspect, the biocatalyst is P. Inregulare.

In one aspect, the first cellulosic feedstock and the second cellulosic feedstock are CCS.

In another aspect, the omega-3 fatty acid is EPA. In a related aspect, the EPA content is about 0.8 to about 1.0% on a dry matter basis.

In one aspect, the protein content is between about 30 to about 50% on a dry matter basis.

In one embodiment, a protein concentrate containing a non-animal based protein enriched in omega-3 fatty acid content including a first slurry and a second slurry is disclosed, where the first slurry is produced by optionally pre-treating a first cellulosic feedstock by extrusion; mixing the first cellulosic feedstock with water and feeding the resulting first mixture into a first reactor; sterilizing the first mixture; cooling the sterilized first mixture and adding a first consortium of saccharifying enzymes under conditions to form a first hydrosylate; cooling the first hydrosylate and inoculating the first hydrosylate with a first biocatalyst that metabolizes sugars in the first hydrosylate; incubating the inoculated first hydrosylate; and optionally adding a second cellulosic feedstock to the inoculated first hydrosylate and continuing incubation until the sugars are depleted to form said first slurry, and the second slurry is produced by mixing the second cellulosic feedstock with water and feeding the resulting second mixture into a second reactor; sterilizing the second mixture; cooling the second sterilized mixture and adding a second consortium of saccharifying enzymes under conditions to form a second hydrosylate; cooling the second hydrosylate and inoculating the second hydrosylate with a second biocatalyst that metabolizes sugars in the second hydrosylate; incubating the second inoculated hydrosylate; optionally adding additional second cellulosic feedstock to the second inoculated hydrosylate and continuing incubation until the sugars are depleted to form said second slurry; where the concentrate is made by mixing the first and second slurries.

In a related aspect, the concentrate includes protein, a biocatalyst, DHA and EPA. In a further related aspect, the concentrate has a protein content of between about 30 to about 50% on a dry matter basis (dmb), a DHA content of between about 0.5 to about 0.7% dmb, and an EPA content of between about 0.8 to about 1.0% dmb.

In another embodiment, a feed composition is disclosed containing a protein content of between about 30 to about 50% on a dry matter basis (dmb), a DHA content of between about 0.5 to about 0.7% dmb, and an EPA content of between about 0.8 to about 1.0% dmb.

### BRIEF DESCRIPTION OF THE DRAWINGS

FIG. 1 shows the performance of protein concentrate without enriched fatty acids. (A) Growth performance (Fish Meal v. Protein Concentrate (PC)); (B) Protein Digestibility (Fish Meal v. PC 1.0 and PC 2.0).

FIG. 2 shows a flow diagram for EtOH/DDGS production.

FIG. 3 shows omega-3 DDGS production process from corn ethanol byproducts (flow diagram).

FIG. 4 shows a table listing the supplement variation from a Plackett-Burman design to determine the effects of minerals and micro-nutrients on DHA production by S. limacinum using 5% DDGS substrate.

### DETAILED DESCRIPTION OF THE INVENTION

Before the present composition, methods, and methodologies are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”. “an”, and “the” include plural references unless the context clearly dictates otherwise. Thus, for example, references to “a nucleic acid” includes one or more nucleic acids, and/or compositions of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Any methods and materials similar or equivalent to those described herein can be used in the practice or testing of the invention, as it will be understood that modifications and variations are encompassed within the spirit and scope of the instant disclosure.

As used herein, “about,” “approximately,” “substantially” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus <10% of particular term and “substantially” and “significantly” will mean plus or minus >10% of the particular term.

As used herein, “consisting essentially of” means, the particular component and may include other components, which other components do not change the novel properties or aspects of the particular component. For example, slurries should consist essential of protein, omega-3 fatty acids, water and biocatalyst, where concentrates should consist essentially of protein omega-3 fatty acids, and biocatalyst.

As used herein, the term “animal” means any organism belonging to the kingdom Animalia and includes, without limitation, humans, birds (e.g. poultry), mammals (e.g. cattle, swine, goal, sheep, cat, dog, mouse and horse) as well as aquaculture organisms such as fish (e.g. trout, salmon, perch), mollusks (e.g. clams) and crustaceans (e.g. lobster and shrimp).

Use of the term “fish” includes all vertebrate fishes, which may be bony (teleosts) or cartilaginous (chondrichthyes) fish species.

As used herein “non-animal based protein” means that the protein concentrate comprises at least 0.81 g of crude fiber/100 g of composition (dry matter basis), which crude fiber is chiefly cellulose, hemicellulose, and lignin material obtained as a residue in the chemical analysis of vegetable substances.

As used herein, “incubation process” means the provision of proper conditions for growth and development of bacteria or cells, where such bacteria or cells use biosynthetic pathways to metabolize various feed stocks. In embodiments, the incubation process may be carried out, for example, under aerobic conditions. In other embodiments, the incubation process may include anaerobic fermentation.

As used herein, a “conversion culture” means a culture of microorganisms which are contained in a medium that comprises material sufficient for the growth of the microorganisms, e.g., water and nutrients. The term “nutrient” means any substance with nutritional value. It can be part of an animal feed or food supplement for an animal. Exemplary nutrients include but are not limited to proteins, peptides, fats, fatty acids, lipids, water and fat soluble vitamins, essential amino acids, carbohydrates, sterols, enzymes, functional organic acids and trace minerals, such as, phosphorus, iron, copper, zinc, manganese, magnesium, cobalt, iodine, selenium, molybdenum, nickel, fluorine, vanadium, tin, and silicon.

The term “pretreated” means that a composition has been subjected to a treatment prior to saccharification.

The term “cellulosic” means a composition comprising cellulose.

“Under conditions to form a hydrosylate” means conditions such as pH, composition of medium, and temperature under which saccharification enzymes are active.

“Hydrosylate” means any product of hydrolysis.

“Consortium of saccharifying enzymes” means one or more enzymes selected primarily, but not exclusively, from the group “glycosidases” which hydrolyze the ether linkages of di-, oligo-, and polysaccharides and are found in the enzyme classification EC 3.2.1.x (Enzyme Nomenclature 1992, Academic Press. San Diego, Calif. with Supplement 1 (1993), Supplement 2 (1994), Supplement 3 (1995, Supplement 4 (1997) and Supplement 5 (in Eur. J. Biochem. (1994) 223:1-5, Eur. J. Biochem. (1995) 232:1-6, Eur. J. Biochem. (1996) 237:1-5, Eur. J. Biochem. (1997) 250:1-6, and Eur. J. Biochem. (199) 264:610-650, respectively]) of the general group “hydrolases” (EC 3.). Glycosidases useful in the present method can be categorized by the biomass component that they hydrolyze. Glycosidases useful for the present method include cellulose-hydrolyzing glycosidases (for example, cellulases, endoglucanases, exoglucanases, cellobiohydrolases, β-glucosidases), hemicellulose-hydrolyzing glycosidases (for example, xylanases, endoxylanases, exoxylanases, β-xylosidases, arabinoxylanases, mannases, galactases, pectinases, glucuronidases), and starch-hydrolyzing glycosidases (for example, amylases, α-amylases, β-amylases, glucoamylases, α-glucosidases, isoamylases). In addition, it may be useful to add other activities to the saccharification enzyme consortium such as peptidases (EC 3.4.x.y), lipases (EC 3.1.1.x and 3.1.4.x), ligninases (EC 1.11.1.x), and feruloyl esterases (EC 3.1.1.73) to help release polysaccharides from other components of the biomass. It is well known in the art that microorganisms that produce polysaccharide-hydrolyzing enzymes often exhibit an activity, such as cellulose degradation, that is catalyzed by several enzymes or a group of enzymes having different substrate specificities. Thus, a “cellulase” from a microorganism may comprise a group of enzymes, all of which may contribute to the cellulose-degrading activity. Commercial or non-commercial enzyme preparations, such as cellulase, may comprise numerous enzymes depending on the purification scheme utilized to obtain the enzyme. Thus, the saccharification enzyme consortium of the present method may comprise enzyme activity, such as “cellulase”, however it is recognized that this activity may be catalyzed by more than one enzyme.

“Slurry” means a thick mixture of water and another substance.

“Biocatalyst” means a substance that initiates or increases the rate of a chemical reaction, and includes, but is not limited to, microorganisms selected from bacteria, filamentous fungi and yeast.

Conversion is the process of culturing microorganisms in a conversion culture under conditions suitable to convert protein/carbohydrate/polysaccharide materials, for example, DDGS material into a high-quality protein concentrate. Adequate conversion means utilization of 90% or more of specified carbohydrates to produce microbial cell mass and/or protein or lipid. In embodiments, conversion may be aerobic or anaerobic.

A large number of plant protein sources may be used in connection with the present disclosure as feed stocks for conversion. The main reason for using plant proteins in the feed industry is to replace more expensive protein sources, like animal protein sources. Another important factor is the danger of transmitting diseases thorough feeding animal proteins to animals of the same species. Examples for plant protein sources include, but are not limited to, protein from the plant family Fabaceae as exemplified by soybean and peanut, from the plant family Brassiciaceae as exemplified by canola, cottonseed, the plant family Asteraceae including, but not limited to sunflower, and the plant family Arecaceae including copra. These protein sources, also commonly defined as oilseed proteins may be fed whole, but they are more commonly fed as a by-product after oils have been removed. Other plant protein sources include plant protein sources from the family Poaceae, also known as Gramineae, like cereals and grains especially corn, wheat and rice or other staple crops such as potato, cassava, and legumes (peas and beans), some milling by-products including germ meal or corn gluten meal, or distillery/brewery by-products. In embodiments, feed stocks for proteins include, but are not limited to, plant materials from soybeans, peanuts, Rapeseeds, barley, canola, sesame seeds, cottonseeds, palm kernels, grape seeds, olives, safflowers, sunflowers, copra, corn, coconuts, linseed, hazelnuts, wheat, rice, potatoes, cassavas, legumes, camelina seeds, mustard seeds, germ meal, corn gluten meal, distillery/brewery by-products, and combinations thereof.

In the fish farming industry the major fishmeal replacers with plant origin reportedly used, include, but are not limited to, soybean meal (SBM), maize gluten meal, Rapeseedicanola (Brassica sp.) meal, lupin (Lupinus sp. like the proteins in kernel meals of de-hulled white (Lupinres albus), sweet (L. angustifolius) and yellow (L. luteus) lupins. Sunflower (Helianthus annuus) seed meal, crystalline amino acids; as well as pea meal (Pisum salivum), Cottonseed (Gossypium sp.) meal, Peanut (groundnut; Arachis hypogaea) meal and oilcake, soybean protein concentrate, corn (Zea mays) gluten meal and wheat (Triticumn aesilvum) gluten, Potato (Solanum tuberosum L.) protein concentrate as well as other plant feedstuffs like Moringa (Moringa oleifera Lam.) leaves, all in various concentrations and combinations.

The protein sources may be in the form of non-treated plant materials and treated and/or extracted plant proteins. As an example, heat treated soy products have high protein digestibility.

In embodiments, distiller's dried grain solubles (DDGS) may be used. DDGS are currently manufactured by the corn ethanol industry. Traditional DDGS comes from dry grind facilities, in which the entire corn kernel is ground and processed. DDGS in these facilities (e.g., “front end” fermentation) typically contains 28-32% protein and between about 9 to about 13% crude fat. However, in “back end” oil extraction, about ⅓ of the corn oil is extracted from, e.g., thin stillage, prior to producing “reduced-oil” DDGS (containing about 5 to about 9% crude fat), which has slightly more protein and fiber relative to DDGS produced without oil extraction. In a related aspect, either reduced oil or traditional DDGS may be used.

The present invention solves this problem and allows for plant protein inclusion levels of up to 40 or even 50%, depending on, amongst other factors, the animal species being fed, the origin of the plant protein source, the ratio of different plant protein sources, the protein concentration and the amount, origin, molecular structure and concentration of the glucan and/or mannan. In embodiments, the plant protein inclusion levels are up to 40%, preferably up to 20 or 30%. Typically the plant protein present in the diet is between 5 and 40%, preferably between 10 or 15 and 30%. These percentages define the percentage amount of a total plant protein source in the animal feed or diet, this includes fat, ashes etc. In embodiments, pure protein levels are up to 50%%, typically up to 45%, in embodiments 5-95%.

The proportion of plant protein to other protein in the total feed or diet may be 5:95 to 95:5, 15:85 to 50:50, or 25:75 to 45:55.

### Microorganisms

The disclosed microorganisms must be capable of converting carbohydrates and other nutrients into a high-quality protein concentrate in a conversion culture. In embodiments, the microorganism is a yeast-like fungus. An example of a yeast-like fungus is Aurobasidium pullulans. Other example microorganisms include yeast such as Kluyveromyces and Pichia spp, Lactic acid bacteria, Trichoderma reesei, Pleurotus ostreaus, Rhizopus spp, and many types of lignocellulose degrading microbes. Generally, exemplary microbes include those microbes that can metabolize stachyose, raffinose, xylose and other sugars. However, it is within the abilities of a skilled artisan to pick, without undue experimentation, other appropriate microorganisms based on the disclosed methods.

In embodiments, the microbial organisms that may be used in the present process include, but are not limited to, Aureobasidium pullulans, Schizochytrium limacinum, Phthium irregulare, Fusarium venenatum, Sclerotium glucanicum, Sphingomonas paucimobilils, Ralstonia eutropha, Rhodospirillum rubrum, Issatchenkia spp. Penicillium spp, Kluyveromyces and Pichia spp, Trichoderma reesei, Pleurotus ostreatus, Rhizopus spp, and combinations thereof. In embodiments, the microbe is S. limacinum or P. Irregulare.

In embodiments, the A. pullulans is adapted to various environments/stressors encountered during conversion. In embodiments, an A. pullulans strain denoted by NRRL deposit No. 50793, which was deposited with the Agricultural Research Culture Collection (NRRL), Peoria, Ill., under the terms of the Budapest Treaty on Nov. 30, 2012, exhibits lower gum production and is adapted to DDGS and SBM based media. In embodiments, an A. pullulans strain denoted by NRRL deposit No. 50792, which was deposited with the Agricultural Research Culture Collection (NRRL), Peoria, Ill., under the terms of the Budapest Treaty on Nov. 30, 2012, is adapted to high levels of the antibiotic tetracycline (e.g., from about 75 μg/ml tetracycline to about 200 μg/ml tetracycline). In embodiments, an A. pullulans strain denoted by NRRL deposit No. 50794, which was deposited with the Agricultural Research Culture Collection (NRRL), Peoria, Ill., under the terms of the Budapest Treaty on Nov. 30, 2012, is adapted to high levels of the antibiotic LACTROL@(e.g., from about 2 μg/ml virginiamycin to about 6 μg/ml virginiamycin). In embodiments, an A. pullulans strain denoted by NRRL deposit No. 50795, which was deposited with the Agricultural Research Culture Collection (NRRL), Peoria, Ill., under the terms of the Budapest Treaty on Nov. 30, 2012, is acclimated to condensed corn solubles.

In other embodiments, an A. pullulans strain may be acclimated to 450-550 ppm LACTROL® (e.g., virginiamycin). In embodiments, an A. pullulans strain may be acclimated to pH 1.5-1.75. In embodiments, an A. pullulans strain may be acclimated to 90-110 ppm Isostab. In embodiments, an A. pullulans strain may be acclimated to 80-100 ppm Betastab. In embodiments, an A. pullulans strain may produce cellulase enzymes and may be acclimated to DDGS. In embodiments, the A. pullulans is selected from NRRL 42023, NRRL 58522 or Y-2311-1.

In other embodiments, a Thermotolerant Pichia strain may be acclimated to CCS and DDGS.

In embodiments, an Issatchenkia spp strain may be acclimated to CCS and DDGS.

In embodiments, a Fusarium venenatum strain may produce cellulase enzymes and may be acclimated to CCS and DDGS.

In other embodiments, a Penicillum spp strain may produce cellulase enzymes and may be acclimated to CCS and DDGS.

In embodiments, Aspergillus orzyae strain may be acclimated to CCS and DDGS.

In embodiments, S. limacinum strain may be acclimated to CCS and DDGS.

In embodiments, P. irregulare strain may be acclimated to CCS and DDGS.

In embodiments, microorganisms which are capable of producing lipids comprising omega-3 and/or omega-6 polyunsaturated fatty acids include those microorganisms which are capable of producing DHA. In a related aspect, such organisms include marine microorganisms, for example algae, such as Thraustochytrids of the order Thraustochytriales, more specifically Thraustochytriales of the genus Thraustochytrium and Schizochytrium, including Thraustochytriales which are disclosed in U.S. Pat. Nos. 5,340,594 and 5,340,742, the disclosures of which are incorporated herein by reference in their entireties. It is to be understood, however, that the invention as a whole is not intended to be so limited, and that one skilled in the art will recognize that the concept of the present invention will be applicable to other microorganisms producing a variety of other compounds, including other lipid compositions, in accordance with the techniques discussed herein.

As used herein a “fatty acid” means an aliphatic monocarboxylic acid. Lipids are recognized to be fats or oils including the glyceride esters of fatty acids along with associated phosphatides, sterols, alcohols, hydrocarbons, ketones, and related compounds.

A commonly employed shorthand system is used in this disclosure to denote the structure of the fatty acids (e.g., Weete, “Lipid Biochemistry of Fungi and Other Organisms”. Plenum Press, New York (1980)). This system uses the letter “C” accompanied by a number denoting the number of carbons in the hydrocarbon chain, followed by a colon and a number indicating the number of double bonds, e.g., C20:5, eicosapentaenoic acid. Fatty acids are numbered starting at the carboxy carbon. Position of the double bonds is indicated by adding the Greek letter delta (A) followed by the carbon number of the double bond; i.e., C20:5omega-3 Δ^{5,8,11,14,17}. The “omega” notation is a shorthand system for unsaturated fatty acids whereby numbering from the carboxy-terminal carbon is used. For convenience, ω3 will be used to symbolize “omega-3,” especially when using the numerical shorthand nomenclature described herein. Omega-3 highly unsaturated fatty acids are understood to be polyethylenic fatty acids in which the ultimate ethylenic bond is 3 carbons from and including the terminal methyl group of the fatty acid. Thus, the complete nomenclature for eicosapentaenoic acid, an omega-3 highly unsaturated fatty acid, would be C20:5ω3Δ^{5,8,11,14,17}. For the sake of brevity, the double bond locations (Δ^{5,8,11,14,17}) will be omitted. Eicosapentaenoic acid is then designated C20:5ω3, Docosapentaenoic acid (C22:50ω3Δ^{5,8,11,14,17}) is C22:5ω3, and Docosahexaenoic acid (C22:6ω3Δ^{5,8,11,14,17}) is C22:5ω3. The nomenclature “highly unsaturated fatty acid” means a fatty acid with 4 or more double bonds. “Saturated fatty acid” means a fatty acid with 1 to 3 double bonds.

Desirable characteristics of the organisms for the production of omega-3 highly unsaturated fatty acids include, but are not limited to those: 1) capable of heterotrophic growth; 2) high content of omega-3 highly unsaturated fatty acids; 3) unicellular, 4) low content of saturated and omega-6 highly unsaturated fatty acids; 5) thermotolerant (ability to grow at temperatures above 30° C.); and 6) euryhaline (able to grow over a wide range of salinities, including low salinities).

Lipids may comprise one or more of the following compounds: lipstatin, statin, TAPS, pimaricine, nystatine, fat-soluble antibiotic (e.g., laidlomycin) fat-soluble anti-oxidant (e.g., co-enzyme Q10), cholesterol, phytosterol, desmosterol, tocotrienol, tocopherol, carotenoid, or xanthophylls, for instance beta-carotene, lutein, lycopene, astaxanthin, zeaxanthin, or canthaxanthin, fatty acids, such as conjungated linoleic acids or polyunsaturated fatty acids (PUFAs). In embodiments, the lipid comprises at least one of the compounds mentioned above at a concentration of at about 5 wt. % or at least about 10 wt. % (with respect to the weight of the lipid).

Lipids may be obtained comprising for example triglyceride, phospholipid, free fatty acid, fatty acid ester (e.g., methyl or ethyl ester) and/or combinations thereof. In embodiments, lipids have a triacylglycerol content of at least about 50%, at least about 70%, or at least about 90%.

In embodiments, a lipid comprises a polyunsaturated fatty acid (PUFA), for instance a PUFA having at least 18 carbon atoms, for instance a C₁₈, C₂₀ or C₂₂ PUFA. In embodiments, the PUFA is an omega-3 PUFA (ω3) or an omega-6 PUFA (ω6). In related aspects, the PUFA has at least 3 double bonds. In embodiments, PUFAs are: docosahexaenoic acid (DHA, 22:6 ω3); γ-linolenic acid (GLA, 18:3 ω6): α-linolenic acid (ALA, 18:3 ω3); dihomo-γ-linolenic acid (DGLA, 20:3 ω6); arachidonic acid (ARA, 20:4 ω6); and eicosapentaenoic acid (EPA, 20:5 ω3).

In embodiments, a lipid comprises at least one PUFA (for instance ARA or DHA) at a concentration of at least about 5 wt. %, for instance at least about 10 wt. %, for instance at least about 20 wt. % (with respect to the weight of the lipid).

The PUFA may be in the form of a (mono-, di, or tri) glyceride, phospholipid, free fatty acid, fatty acid ester (e.g. methyl or ethyl ester) and/or combinations thereof. In a related aspect, a lipid is obtained wherein at least about 50% of all PUFAs are in triglyceride form.

The lipid may be an oil or fat, for instance an oil comprising a PUFA.

In embodiments, the process as disclosed herein increases omega-3 fatty acid content of a non-animal feedstock from about 0% to about 0.24%, from about 0.24% to about 1.5%, from about 1.5% to about 2%, from about 2% to about 3% on a dry matter basis (dmb). In one aspect, S. limacinum fermentation on DDGS increases the DHA content from about 0% to about 0.3%, from about 0% to about 0.24%, from about 0% to about 1.5%, or from about 0% to about 3% (dmb). In a related aspect, S. limacinum fermentation on DDGS increases the protein content to about 36% or to about 50%, or to about 55% (dmb). In another aspect, P. irregulare fermentation on CCS increase EPA content from about 0% to about 0.94%, about 0% to about 1.5%, from about 0% to about 2%, or from about 0% to about 3% (dmb). In a related aspect, P. irregulare fermentation on CCS increases the protein content to about 34.5% or to about 40%, or to greater than about 50% (dmb).

The cells may be any cells comprising a lipid. Typically, the cells have produced the lipid. The cells may be whole cells or ruptured cells. The cells may be of any suitable origin. The cells may for instance be plant cells, for instance cells from seeds or cells of a microorganism (microbial cells or microbes). Examples of microbial cells or microbes are yeast cell, bacterial cells, fungal cells, and algal cells. In embodiments, fungi may be use, for example, such as the order Mucorales, for example Mortierella, Phycomyces, Blakeslea, Aspergillus, Thrausiochytrium, Pythium or Entomophthora. In embodiments, a source of arachidonic acid (ARA) may be from Mortierella alpina, Blakeslea trispora, Aspergillus terreus or Pythium insidiosum. Algae may be dinoflagellate and/or include Porphyridium, Niszchia, or Crypthecodinium (e.g. Crypthecodinium cohnii). Yeasts may include those of the genus Pichia or Saccharomyces, such as Pichia ciferii. Bacteria may be of the genus Propionibacterium. Examples of plant cells comprising a lipid are cells from soy bean, rape seed, canola, sunflower, coconut, flax and palm seed. In embodiments, the cells are plant cells comprising lipid which lipid comprises ARA. In embodiments, the cells as disclosed may be used alone or in combination.

In embodiments, the cells are used in fermentation.

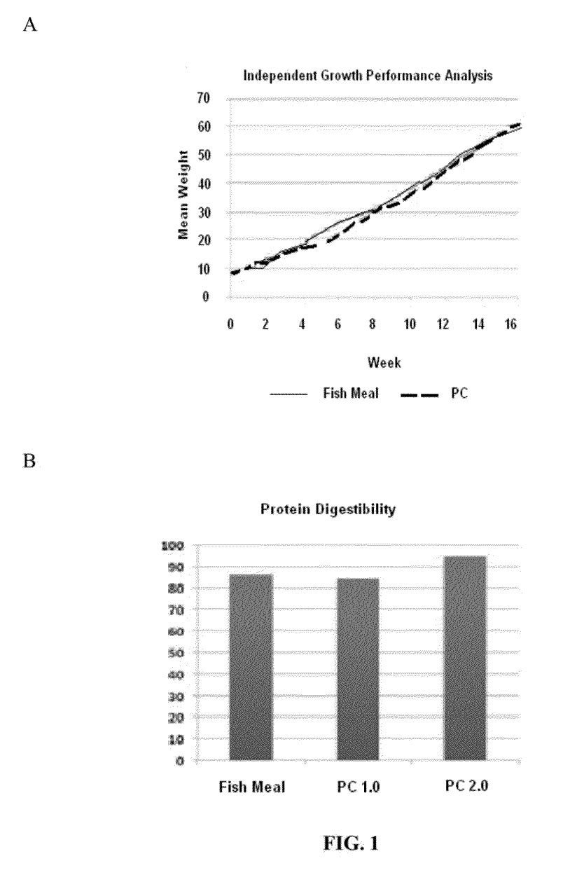

Various plant-based protein sources have been used in aquaculture diets, including DDGS (10-35% inclusion) and soy bean meal (5-30% inclusion) as partial replacements for marine-derived fish meal. These protein sources have limitations, particularly with piscivorous species. DDGS contains high levels of fiber and insufficient levels of essential amino acids (e.g., lysine and methionine). In embodiments, the methods as disclosed herein provide DDGS derived products with reduced fiber content and improved amino acid profiles using a micro-fungal process, resulting in a significantly higher fish digestibility. Soy bean meal (SBM) is limited by anti-nutritional factors (e.g., stachyose, raffinose, trypsin inhibitors). In a related aspect, the methods as disclosed herein provide a soy protein concentrate wherein the anti-nutritional factors have been removed, while at the same time said concentrate has an increase in protein levels, enabling a replacement of fish meal in yellow perch diets (FIG. 1). In another related aspect, the methods as described herein provide for the production of a product which also provides the required omega-3 fatty acids that is normally provided by fish oil.

The omega-3 fatty acid profile of fish oil is high in EPA and DHA, but low in α-linolenic acid (ALA). By contrast, flaxseed oil contains high levels of ALA, lacks DHA and EPA, and also contains high titers of omega-6 fatty acids, which reduces the effectiveness of omega-3 fatty acids. Thus, flaxseed oil has not succeeded as a fish oil replacement. Algal oil is much more appropriate due to its proper balance of omega-3 fatty acids and many efforts are underway to exploit this opportunity. Unfortunately, photoautotrophic platforms for algal production have low productivity in relation to capital and/or opportunity costs, this limiting these systems to higher value human supplement markets. Heterotrophic algal systems have higher productivities, can utilize low cost waste materials as feedstocks, and can use lower cost bioreactors. However, downstream processing for cell recovery (centrifugation or filtration) and oil extraction and drying are significant costs that must be overcome. Alternatively, the processes as disclosed herein retain microbially-derived omega-3 fatty acids, along with the microbial mass, in the final omega-3 DDGS product. In embodiments, the microbial conversion of distiller's wet grains and condensed corn solubles (CCS) is integrated prior to their normal blending and drying in corn ethanol facilities, thus, yielding a DDGS with enhanced levels of DHA, EPA and protein.

In embodiments, S. limacinum and may be used with distiller's grains to produce DHA. In other embodiments, P. irregulare may be used with CCS to produce EPA. Both are oleaginous microbes that can produce more than 25% lipid on a dry cell weight basis. S. limacinum is classified as a marine protist (Thraustochytrids) that can accumulate >50% of its dry weight as lipids, of which more than 25% are DHA. Cells are heterogeneous in size, approximately 6-21 um in diameter, with a granular cytoplasm containing oil micelles. In embodiments, the may serve as a source of carotenoids, such as astaxanthin, which has good antioxidant properties. Some Thraustochytrids have been known to produce proteases, lipases, esterases, acid and alkaline phosphatases, cellulases, and xylanases, thus, in a related aspect, such protists may afford a process with the ability to hydrolyze fibers in DDGS.

P. irregulare is a filamentous fungus which has the highest reported EPA production of all fungi, at 25% of total lipids content when grown on lactose in a 14 L reactor.

Glucose is most commonly used for omega-3 fatty acid production with these microbes, but maltose and starch may also been used. To reduce production costs, lower cost byproducts may also be used, including but not limited to, crude glycerol, residues from beer and potato processing, sweet sorghum juice, thin stillage, and sweet whey permeate. Although such a approach may be tempered by the use of costly nitrogen sources (yeast extract, peptone, and tryptone). In a related aspect, use of the dilute byproducts may require that cells be recovered and dried before being used as an omega-3 fatty acid supplement. In embodiment, omega-3 production may be integrated into the DDGS recovery section of ethanol plants to take advantage of these concentrated processing streams and minimize recovery/drying costs. In a related aspect, distiller's wet grains and CCS contain sugars, organic acids, glycerol, corn oil, and other nutrients that will support omege-3 production.

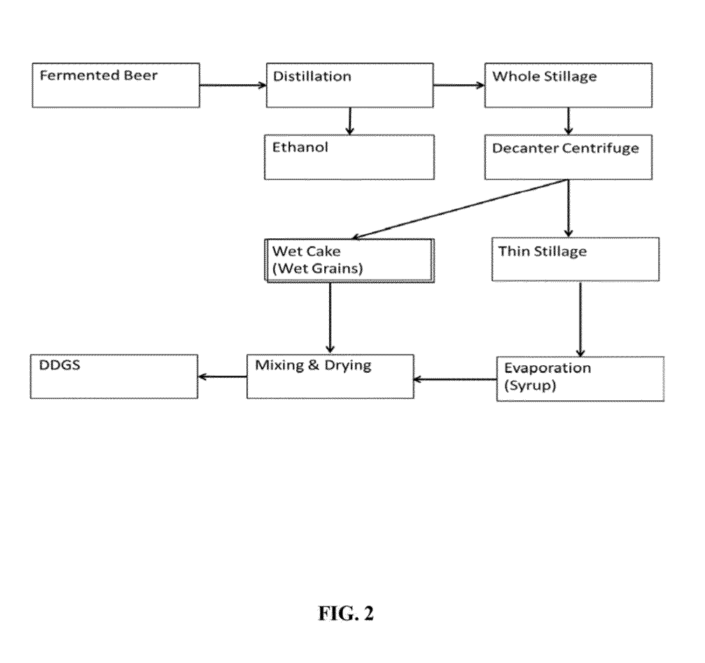

DDGS is a co-product of the corn ethanol industry (FIG. 2) and current U.S. production capacity is about 40 million tons/yr. The large quantities and lower protein content of DDGS have led to a reduced market price for DDGS compared to other protein meals like SBM, canola, and animal derived meals. DDGS has been traditionally fed to ruminant animals, but it does have potential for use as a fish meal replacer in aquaculture diets. Due to the removal of starch in the ethanol process, DDGS contains approximately 3.5-12.8% fat, 26.8-33.7% protein, 5.4-10.6% fiber, and 2.0-9.8 minerals. DDGS contains none of the anti-nutritional factors (e.g., trypsin inhibitors, oligosaccharides) found in SBM. However. DDGS contains fiber and lower amounts of the essential amino acids lysine and methionine, compared to fish meal. DDGS has excellent potential as a substrate for EPA and DHA production due to its high content of metabolizable carbon sources for microbes (oil, glycerol, and fibers which could be hydrolyzed into sugars).

The combination of omega-3 enhanced DDGS with fermentation methods as disclosed in, e.g., U.S. Pub. No. 20130142905 and U.S. Ser. No. 14/453,597 (each of which is incorporated by reference in its entirety) provides a feedstuff that addresses the needs for oil, omega-3 fatty acids, and protein in aquaculture diets. An advantage of this process as disclosed includes lower production costs due to the inexpensive feedstock and minimal processing steps and higher performance in fish due to the nutritional superiority of omega-3 DDGS product which addresses multiple nutritional needs.

In embodiments, S. limacinum in non-pretreated DDGS results in about 0.61% DHA and about 36% protein. In a related aspect, performance may be increased to the levels shown in Table 1 by pre-treating distiller's wet grains via extrusion, followed by enzymatic saccharification to convert fibers into simple sugars. In previous processes with A. pullulans protein levels have been increased from 33 to >50% by applying a similar extrusion and saccharification process (see, e.g., U.S. Pub. No. 20130142905). In embodiments, CCS is added in a fed-batch mode to provide additional glycerol, as well as cause a nitrogen limitation to trigger additional DHA production. In a related aspect, a biphasic process in which an inexpensive nitrogen source may be added initially to boost cell mass and thus protein levels is disclosed. CCS may be added to provide glycerol (and cause nitrogen limitation) while aeration may be reduced to stress cells to produce additional DHA. Preliminary work has also established that P. irregular can convert diluted CCS into 0.94% EPA and 34.5% protein. In embodiments, CCS is added in a fed batch mode to provide additional glycerol. In certain aspects, a biphasic process may initially boost cell mass/protein levels, which is followed by a fed-batch process with reduced aeration to increase EPA levels (Table 1).

TABLE 1
Preliminary Performance (dmb).

| Product Line | Component | Data |
|---|---|---|
| DDG - | DHA | 0.61% |
| S. limacinum | Protein | 36% |
| CCS - | EPA | 0.94% |
| P. irregulare | Protein | 34.5% |

In embodiments, the distiller's wet grain and CCS processing streams may be blended in different ratios and then centrifuged and dried into omega-3 DDGS. These may then be tested in perch digestibility and feeding trials at various replacement levels for fish oil and fish meal. In one aspect, the omega-3 DDGS performs at least as well as fish meal/oil feeds (growth rate, feed conversion, and protein efficiency) at 100% replacement levels, and at much lower costs. Viscera characteristics and intestinal histology may be examined to assess fish responses.

In embodiments, additional optimization steps may include, but are not limited to 1) optimizing the production process (strain enhancement, omitting cellulases), 2) evaluating the omega-3 DDGS in a range of commercially important fishes, 3) validating process costs and energy requirements, and 4) completing steps for scale-up and commercialization.

In embodiments, in addition to generating a protein source to replace fish meal, the process as disclosed herein integrates microbial production of two critical omega-3 fatty acids (DHA and EPA). The feedstocks may include distiller's wet grain for production of DHA and protein from S. limacinum and CCS for production of EPA and protein from P. irregulare.

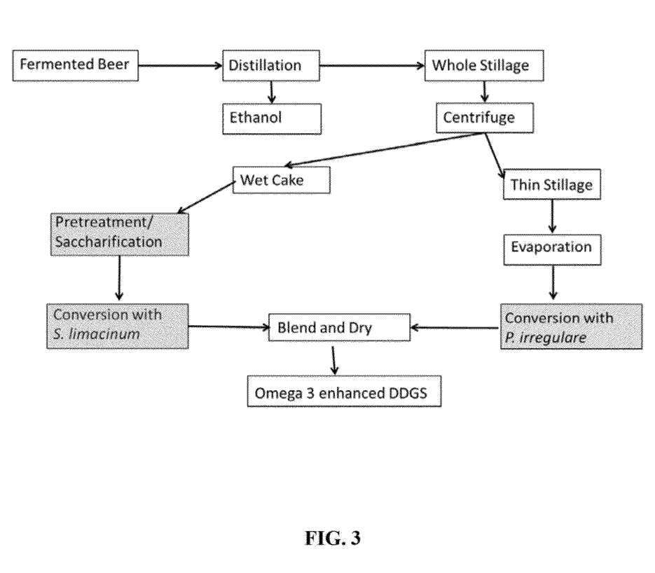

In embodiments, the method as disclosed may be summarized as shown in FIG. 3, which depicts an approach to converting corn ethanol processing by-products into omega-3 DDGS, which product may be used to replace fish meal and fish oil in aquaculture feeds. In a related aspect, distiller's wet grain may be subjected to extrusion pretreatment and enzymatic hydrolysis (under optimized conditions), followed by incubation with S. limacinum for production of DHA and single-cell protein. CCS may be added to boost DHA production. In one aspect, cellulases may be omitted sequentially to evaluate if co-culturing with cellulolytic microbes may be used as substitutes for the enzymes. In another aspect, CCS may be mixed with water as needed and then inoculated with P. irregulare for production of EPA and single-cell protein.

In embodiment, following incubation, the process streams may be mixed to achieve desired levels of DHA, EPA, and protein. Solids may be recovered by centrifugation and dried, with supernatant evaluated for recycling to the front end of the process. In one aspect, solids may be formulated into omega-3 DDGS based feeds and tested in perch feeding trials, with control diets prepared using fish meal and fish oil. Performance (e.g., digestibility, growth, feed conversion, protein efficiency), viscera characteristics, and intestinal histology may be examined to assess fish responses. In another aspect, the processes as disclosed herein allows for optimization of omega-3 DDGS production process by determining optimum pretreatment and conversion conditions while minimizing process inputs, improving the performance and robustness of the microbes, testing the resultant grower feeds for a range of commercially important fishes, validating process costs and energy requirements, and completing initial steps for scale-up and commercialization.

### Dietary Formulations

In exemplary embodiments, the protein concentrate and lipids recovered are used in dietary formulations. In embodiments, the recovered protein concentrate (PC) will be the only protein source in a dietary formulation. Protein source percentages in dietary formulations are not meant to be limiting and may include 24 to 80% protein. In embodiments, the protein concentrate will be more than about 50%, more than about 60%, or more than about 70% of the total dietary formulation protein source. Recovered PC/lipid combinations may replace sources such as fish meal, soybean meal, wheat and corn flours and glutens and concentrates, and animal byproduct such as blood, poultry, and feather meals. Dietary formulations using recovered PC/lipids may also include supplements such as mineral and vitamin premixes to satisfy remaining nutrient requirements as appropriate.

In certain embodiments, performance of the PC, such as high-quality protein from DDGS or other upgraded plant-based meals alone or in combination with generated lipids, may be measured by comparing the growth, feed conversion, protein efficiency, and survival of animal on a high-quality protein concentrate dietary formulation to animals fed control dietary formulations, such as fish-meal. In embodiments, test formulations contain consistent protein, lipid, and energy contents. For example, when the animal is a fish, viscera (fat deposition) and organ (liver and spleen) characteristics, dress-out percentage, and fillet proximate analysis, as well as intestinal histology (enteritis) may be measured to assess dietary response.

As is understood, individual dietary formulations containing the recovered PC and/or combinations with recovered lipids may be optimized for different kinds of animals. In embodiments, the animals are fish grown in commercial aquaculture. Methods for optimization of dietary formulations are well-known and easily ascertainable by the skilled artisan without undue experimentation.

Complete grower diets may be formulated using PC in accordance with known nutrient requirements for various animal species. In embodiments, the formulation may be used for yellow perch (e.g., 42% protein, 8% lipid). In embodiments, the formulation may be used for rainbow trout (35% protein, 16% lipid). In embodiments, the formulation may be used for any one of the animals recited supra.

Basal mineral and vitamin premixes for plant-based diets may be used to ensure that micro-nutrient requirements will be met. Any supplements (as deemed necessary by analysis) may be evaluated by comparing to an identical formulation without supplementation; thus, the feeding trial may be done in a factorial design to account for supplementation effects. In embodiments, feeding trials may include a fish meal-based control diet and ESPC- and LSPC-based reference diets [traditional SPC (TSPC) is produced from solvent washing soy flake to remove soluble carbohydrate; texturized SPC (ESPC) is produced by extruding TSPC under moist, high temperature; and low-antigen SPC (LSPC) is produced from TSPC by altering the solvent wash and temperature during processing. Pellets for feeding trials may be produced using the lab-scale single screw extruder (e.g., BRABENDERPLASTI-CORDER EXTRUDER Model PL2000).

### Feeding Trials

In embodiments, a replication of four experimental units per treatment (i.e., each experimental and control diet blend) may be used (e.g., about 60 to 120 days each). Trials may be carried out in 110-L circular tanks (20 fish/tank) connected in parallel to a closed-loop recirculation system driven by a centrifugal pump and consisting of a solids sump, and bioreactor, filters (100 μm bag, carbon and ultra-violet). Heat pumps may be used as required to maintain optimal temperatures for species-specific growth. Water quality (e.g., dissolved oxygen, pH, temperature, ammonia and nitrite) may be monitored in all systems.

In embodiments, experimental diets may be delivered according to fish size and split into two to five daily feedings. Growth performance may be determined by total mass measurements taken at one to four weeks (depending upon fish size and trial duration); rations may be adjusted in accordance with gains to allow satiation feeding and to reduce waste streams. Consumption may be assessed biweekly from collections of uneaten feed from individual tanks. Uneaten feed may be dried to a constant temperature, cooled, and weighed to estimate feed conversion efficiency. Feed protein and energy digestibilities may be determined from fecal material manually stripped during the midpoint of each experiment or via necropsy from the lower intestinal tract at the conclusion of a feeding trial. Survival, weight gain, growth rate, health indices, feed conversion, protein and energy digestibilities, and protein efficiency may be compared among treatment groups. Proximate analysis of necropsied fishes may be carried out to compare composition of fillets among dietary treatments. Analysis of amino and fatty acids may be done as needed for fillet constituents, according to the feeding trial objective. Feeding trial responses of dietary treatments may be compared to a control (e.g., fish meal) diet response to ascertain whether performance of PC diets meet or exceed control responses.

Statistical analyses of diets and feeding trial responses may be completed with an a priori α=0.05. Analysis of performance parameters among treatments may be performed with appropriate analysis of variance or covariance (Proc Mixed) and post hoc multiple comparisons, as needed. Analysis of fish performance and tissue responses may be assessed by nonlinear models.

In embodiments, the present disclosure proposes to convert fibers and other carbohydrates in DDGS into additional protein using, for example, a GRAS-status microbe. A microbial exopolysaccharide (i.e., gum) may also be produced that may facilitate extruded feed pellet formation, negating the need for binders. This microbial gum may also provide immunostimulant activity to activate innate defense mechanisms that protect fish from common pathogens resulting from stressors. Immunoprophylactic substances, such as β-glucans, bacterial products, and plant constituents, are increasingly used in commercial feeds to reduce economic losses due to infectious diseases and minimize antibiotic use. The microbes of the present disclosure also produce extracellular peptidases, which should increase corn protein digestibility and absorption during metabolism, providing higher feed efficiency and yields. As disclosed herein, this microbial incubation process provides a valuable, sustainable aquaculture feed that is less expensive per unit of protein than SBM, SPC, and fish meal.

As disclosed, the instant microbes may metabolize the individual carbohydrates in DDGS, producing both cell mass (protein) and a microbial gum. Various strains of these microbes also enhance fiber deconstruction. The microbes of the present invention may also convert soy and corn proteins into more digestible peptides and amino acids. In embodiments, the following actions in may be performed: 1) determining the efficiency of using select microbes of the present disclosure to convert pretreated DDGS and the like, yielding a protein concentrate (PC) with a protein concentration of between about 45% and 55% or at least about 50%, and 2) assessing the effectiveness of PC in replacing fish meal. In embodiments, optimizing DDGS pretreatment and conversion conditions may be carried out to improve the performance and robustness of the microbes, test the resultant grower feeds for a range of commercially important fishes, validate process costs and energy requirements, and complete steps for scale-up and commercialization. In embodiments, the PC of the present disclosure may be able to replace at least 50% of fish meal, while providing increased growth rates and conversion efficiencies. Production costs should be less than commercial soy protein concentrate (SPC) and substantially less than fish meal.

After extrusion pretreatment, cellulose-deconstructing enzymes may be evaluated to generate sugars, which microbes of the present disclosure may convert to protein and gum. In embodiments, sequential omission of these enzymes and evaluation of co-culturing with cellulolytic microbes may be used. Ethanol may be evaluated to precipitate the gum and improve centrifugal recovery of the PC. After drying, the PC may be incorporated into practical diet formulations. In embodiments, test grower diets may be formulated (with mineral and vitamin premixes) and comparisons to a fish-meal control and commercial SPC (SPC is distinctly different from soybean meal, as it contains traces of oligopolysaccharides and antigenic substances glycinin and b-conglycinin) diets in feeding trials with a commercially important fish, e.g., yellow perch or rainbow trout, may be performed. Performance (e.g., growth, feed conversion, protein efficiency), viscera characteristics, and intestinal histology may be examined to assess fish responses.

In other embodiments, optimizing the PC/lipid production process by determining optimum pretreatment and conversion conditions while minimizing process inputs, improving the performance and robustness of the microbe, testing the resultant grower feeds for a range of commercially important fishes, validating process costs and energy requirements, and completing initial steps for scale-up and commercialization may be carried out.

In the past few years, a handful of facilities have installed a dry mill capability that removes corn hulls and germ prior to the ethanol production process. This dry fractionation process yields a DDGS with up to 42% protein (hereafter referred to as dryfrac DDGS). In embodiments, conventional and dryfrac DDGS under conditions previously determined to rapidly generate a sufficient amount of high protein DDGS (HP-DDGS) for use in perch feeding trials may be compared. In embodiments, careful monitoring of the performance of this conversion (via chemical composition changes) is carried out and parameters with the greatest impact on HP-DDGS quality identified. In some embodiments, low oil DDGS may be used as a substrate for conversion, where such low oil DDGS has a higher protein level than conventional DDGS. In a related aspect, low oil DDGS increase growth rates of A. pullulans compared to conventional DDGS.

Several groups are evaluating partial replacement of fish-meal with plant derived proteins, such as soybean meal and DDGS. However, the lower protein content, inadequate amino acid balance, and presence of anti-nutritional factors have limited the replacement levels to 20-40%. Preliminary growth trials indicate that no current DDGS or SPC-based diets provide performance similar to fish-meal control diets. Several deficiencies have been identified among commercially produced DDGS, principally in protein and amino acid composition, which impart variability in growth performance and fish composition. However, HP-DDGS diets as disclosed herein containing nutritional supplements (formulated to meet or exceed all requirements) have provided growth results that are similar to or exceed fish-meal controls. Thus, the processes as disclosed herein and products developed therefrom provide a higher quality HP-DDGS (relative to nutritional requirements) and support growth performance equivalent to or better than diets containing fish meal.

Fish that can be fed the fish feed composition of the present disclosure include, but are not limited to, Siberian sturgeon, Sterlet sturgeon, Starry sturgeon, White sturgeon, Arapaima, Japanese eel, American eel, Short-finned eel, Long-finned eel, European eel, Chanos chanos, Milkfish, Bluegill sunfish, Green sunfish, White crappie, Black crappie, Asp, Catla, Goldfish, Crucian carp, Mud carp, Mrigal carp, Grass carp, Common carp, Silver carp, Bighead carp, Orangefin labeo, Roho labeo, Hfoven's carp, Wuchang bream, Black carp. Golden shiner, Nilem carp, White amur bream, Thai silver barb, Java, Roach, Tench, Pond loach, Bocachico, Dorada, Cachama, Cachama Blanca, Paco, Black bullhead, Channel catfish, Bagrid catfish, Blue catfish, Wels catfish, Pangasius (Swai, Tra, Basa) catfish, Striped catfish, Mudfish, Philippine catfish, Hong Kong catfish, North African catfish, Bighead catfish, Sampa, South American catfish, Atipa, Northern pike, Ayu sweetfish, Vendace, Whitefish, Pink salmon, Chum salmon, Coho salmon, Masu salmon, Rainbow trout. Sockeye salmon, Chinook salmon, Atlantic salmon, Sea trout, Arctic char, Brook trout, Lake trout, Atlantic cod, Pejerrey, Lai, Common snook. Barramundi/Asian sea bass, Nile perch, Murray cod, Golden perch. Striped bass, White bass, European seabass, Hong Kong grouper, Areolate grouper, Greasy grouper, Spotted coraigrouper, Silver perch. White perch, Jade perch, Largemouth bass. Smallmouth bass, European perch, Zander (Pike-perch), Yellow Perch, Sauger, Walleye, Bluefish, Greater amberjack, Japanese amberjack, Snubnose pompano, Florida pompano, Palometa pompano, Japanese jack mackerel, Cobia, Mangrove red snapper, Yellowtail snapper, Dark seabream, White seabream, Crimson seabream, Red seabream. Red porgy, Goldlined seabream, Gilthead seabream, Red drum, Green terror, Blackbelt cichlid, Jaguar guapote, Mexican mojarra, Pearlspot, Three spotted tilapia, Blue tilapia, Longfin tilapia, Mozambique tilapia, Nile tilapia, Tilapia. Wami tilapia, Blackchin tilapia, Redbreast tilapia, Redbelly tilapia, Golden grey mullet, Largescale mullet, Gold-spot mullet, Thinlip grey mullet, Leaping mullet, Tade mullet. Flathead grey mullet, White mullet, Lebranche mullet, Pacific fat sleeper, Marble goby, White-spotted spinefoot, Goldlined spinefoot, Marbled spinefoot, Southern bluefin tuna, Northern bluefin tuna, Climbing perch, Snakeskin gourami, Kissing gourami, Giant gourami, Snakehead, Indonesian snakehead. Spotted snakehead, Striped snakehead, Turbot, Bastard halibut (Japanese flounder), Summer Flounder, Southern flounder, Winter flounder, Atlantic Halibut, Greenback flounder, Common sole, and combinations thereof.

It will be appreciated by the skilled person that the fish feed composition of the present disclosure may be used as a convenient carrier for pharmaceutically active substances.

The fish feed composition according to present disclosure may be provided as a liquid, pourable emulsion, or in the form of a paste, or in a dry form, for example as an extrudate, granulate, a powder, or as flakes. When the fish feed composition is provided as an emulsion, a lipid-in-water emulsion, it is may be in a relatively concentrated form. Such a concentrated emulsion form may also be referred to as a pre-emulsion as it may be diluted in one or more steps in an aqueous medium to provide the final enrichment medium for the organisms.

In embodiments, cellulosic-containing starting material for the microbial-based process as disclosed is corn. Corn is about two-thirds starch, which is converted during a fermentation and distilling process into ethanol and carbon dioxide. The remaining nutrients or fermentation products may result in condensed distiller's solubles or distiller's grains such as DDGS, which can be used in feed products. In general, the process involves an initial preparation step of dry milling or grinding of the corn. The processed corn is then subject to hydrolysis and enzymes added to break down the principal starch component in a saccharification step. The following step of fermentation is allowed to proceed upon addition of a microorganism (e.g., yeast) provided in accordance with an embodiment of the disclosure to produce gaseous products such as carbon dioxide. The fermentation is conducted for the production of ethanol which may be distilled from the fermentation broth. The remainder of the fermentation medium may then be dried to produce fermentation products including DDGS. This step usually includes a solid/liquid separation process by centrifugation wherein a solid phase component may be collected. Other methods including filtration and spray dry techniques may be employed to effect such separation. The liquid phase components may be subjected further afterwards to an evaporation step that can concentrate soluble coproducts, such as sugars, glycerol and amino acids, into a material called syrup or condensed corn solubles (CCS). The CCS may then be recombined with the solid phase component to be dried as incubation products (DDGS). It shall be understood that the subject compositions and may be applied to new or already existing ethanol plants based on dry milling to provide an integrated ethanol production process that also generates fermentation products with increased value.

In embodiments, incubation products produced according to the present disclosure have a higher commercial value than the conventional fermentation products. For example, the incubation products may include enhanced dried solids with improved amino acid and micronutrient content. A “golden colored” product can be thus provided which generally indicates higher amino acid digestibility compared to darker colored SP. For example, a light-colored SP may be produced with an increased lysine concentration in accordance with embodiments herein compared to relatively darker colored products with generally less nutritional value. The color of the products may be an important factor or indicator in the assessing the quality and nutrient digestibility of the fermentation products or SP. Color is used as an indicator of exposure to excess heat during drying causing caramelization and Maillard reactions of the free amino groups and sugars, reducing the quality of some amino acids.

The basic steps in a dry mill or grind ethanol manufacturing process may be described as follows: milling or grinding of corn or other grain product, saccharification, fermentation, and distillation. For example, selected whole corn kernels may be milled or ground with typically either hammer mills or roller mills. The particle size can influence cooking hydration and subsequent enzymatic conversion. The milled or ground corn can be then mixed with water to make a mash that is cooked and cooled. It may be useful to include enzymes during the initial steps of this conversion to decrease the viscosity of the gelatinized starch. The mixture may be then transferred to saccharification reactors, maintained at selected temperatures such as 140° F., where the starch is converted by addition of saccharifying enzymes to fermentable sugars such as glucose or maltose. The converted mash can be cooled to desired temperatures such as 84° F., and fed to fermentation reactors where fermentable sugars are converted to carbon dioxide by the use of selected strains of microbes provided in accordance with the disclosure that results in more nutritional fermentation products compared to more traditional ingredients such as Saccharomyces yeasts. The resulting product may be flashed to separate out carbon dioxide and the resulting liquid may be fed to a recovery system consisting of distillation columns and a stripping column. The ethanol stream may be directed to a molecular sieve where remaining water is removed using adsorption technology. Purified ethanol, denatured with a small amount of gasoline, may produce fuel grade ethanol. Another product may be produced by further purifying the initial distillate ethanol to remove impurities, resulting in about 99.95% ethanol for non-fuel uses.

The whole stillage may be withdrawn from the bottom of the distillation unit and centrifuged to produce distiller's wet grains (DWG) and thin stillage (liquids). The DWG may leave the centrifuge at 55-65% moisture, and may either be sold wet as cattle feed or dried as enhanced fermentation products provided in accordance with the disclosure. These products include an enhanced end product that may be referred to herein as distiller's dried grains (DDG). Using an evaporator, the thin stillage (liquid) may be concentrated to form distiller's solubles, which may be added back to and combined with a distiller's grains process stream and dried. This combined product in accordance with embodiments of the disclosure may be marketed as an enhanced fermentation product having increased amino acid and micronutrient content. It shall be understood that various concepts of the disclosure may be applied to other fermentation processes known in the field other than those illustrated herein.

Another aspect of the present invention is directed towards complete fish meal compositions with an enhanced concentration of nutrients which includes microorganisms characterized by an enhanced concentration of nutrients such as, but not limited to, fats, fatty acids, lipids such as phospholipid, vitamins, essential amino acids, peptides, proteins, carbohydrates, sterols, enzymes, and trace minerals such as, iron, copper, zinc, manganese, cobalt, iodine, selenium, molybdenum, nickel, fluorine, vanadium, tin, silicon, and combinations thereof.

In an incubation process of the present disclosure, a carbon source may be hydrolyzed to its component sugars by microorganisms to produce alcohol and other gaseous products. Gaseous product includes carbon dioxide and alcohol includes ethanol. The incubation products obtained after the incubation process are typically of higher commercial value. In embodiments, the incubation products contain microorganisms that have enhanced nutrient content than those products deficient in the microorganisms. The microorganisms may be present in an incubation system, the incubation broth and/or incubation biomass. The incubation broth and/or biomass may be dried (e.g., spray-dried), to produce the incubation products with an enhanced content of the nutritional contents.

For example, the spent, dried solids recovered following the incubation process are enhanced in accordance with the disclosure. These incubation products are generally non-toxic, biodegradable, readily available, inexpensive, and rich in nutrients. The choice of microorganism and the incubation conditions are important to produce a low toxicity or non-toxic incubation product for use as a feed or nutritional supplement. While glucose is the major sugar produced from the hydrolysis of the starch from grains, it is not the only sugar produced in carbohydrates generally. Unlike the SPC or DDG produced from the traditional dry mill ethanol production process, which contains a large amount of non-starch carbohydrates (e.g., as much as 35% percent of cellulose and arabinoxylans-measured as neutral detergent fiber, by dry weight), the subject nutrient enriched incubation products produced by enzymatic hydrolysis of the non-starch carbohydrates are more palatable and digestible to the non-ruminant.

The nutrient enriched incubation product of this disclosure may have a nutrient content of from at least about 1% to about 95% by weight. The nutrient content is preferably in the range of at least about 0%-20%, 20%-30%, 30%-40%, 40%-50%, 50%-60%, 60%-70%, and 70%-80% by weight. The available nutrient content may depend upon the animal to which it is fed and the context of the remainder of the diet, and stage in the animal life cycle. For instance, beef cattle require less histidine than lactating cows. Selection of suitable nutrient content for feeding animals is well known to those skilled in the art.

The incubation products may be prepared as a spray-dried biomass product. Optionally, the biomass may be separated by known methods, such as centrifugation, filtration, separation, decanting, a combination of separation and decanting, ultrafiltration or microfiltration. The biomass incubation products may be further treated to facilitate rumen bypass. In embodiments, the biomass product may be separated from the incubation medium, spray-dried, and optionally treated to modulate rumen bypass, and added to feed as a nutritional source. In addition to producing nutritionally enriched incubation products in an incubation process containing microorganisms, the nutritionally enriched incubation products may also be produced in transgenic plant systems. Methods for producing transgenic plant systems are known in the an. Alternatively, where the microorganism host excretes the nutritional contents, the nutritionally-enriched broth may be separated from the biomass produced by the incubation and the clarified broth may be used as an animal feed ingredient, e.g., either in liquid form or in spray dried form.

The incubation products obtained after the incubation process using microorganisms may be used as an animal feed or as food supplement for humans. The incubation product includes at least one ingredient that has an enhanced nutritional content that is derived from a non-animal source (e.g., a bacteria, yeast, and/or plant). In particular, the incubation products are rich in at least one or more of fats, fatty acids, lipids such as phospholipid, vitamins, essential amino acids, peptides, proteins, carbohydrates, sterols, enzymes, and trace minerals such as, iron, copper, zinc, manganese, cobalt, iodine, selenium, molybdenum, nickel, fluorine, vanadium, tin and silicon. In embodiments, the peptides contain at least one essential amino acid. In other embodiments, the essential amino acids are encapsulated inside a subject modified microorganism used in an incubation reaction. In embodiments, the essential amino acids are contained in heterologous polypeptides expressed by the microorganism. Where desired, the heterologous polypeptides are expressed and stored in the inclusion bodies in a suitable microorganism (e.g., fungi).

In embodiments, the incubation products have a high nutritional content. As a result, a higher percentage of the incubation products may be used in a complete animal feed. In embodiments, the feed composition comprises at least about 15% of incubation product by weight. In a complete feed, or diet, this material will be fed with other materials. Depending upon the nutritional content of the other materials, and/or the nutritional requirements of the animal to which the feed is provided, the modified incubation products may range from 15% of the feed to 100% of the feed. In embodiments, the subject incubation products may provide lower percentage blending due to high nutrient content. In other embodiments, the subject incubation products may provide very high fraction feeding, e.g. over 75%. In suitable embodiments, the feed composition comprises at least about 20%, at least about 25%, at least about 30%, at least about 35%, at least about 40%, at least about 45%, at least about 50%, at least about 60%, at least about 70%, or at least about 75% of the subject incubation products. Commonly, the feed composition comprises at least about 20% of incubation product by weight. More commonly, the feed composition comprises at least about 15-25%, 25-20%, 20-25%, 30%-40%, 40%-50%, 50%-60%, or 60%-70% by weight of incubation product. Where desired, the subject incubation products may be used as a sole source of feed.

The complete fish meal compositions may have enhanced amino acid content with regard to one or more essential amino acids for a variety of purposes, e.g., for weight increase and overall improvement of the animal's health. The complete fish meal compositions may have enhanced amino acid content because of the presence of free amino acids and/or the presence of proteins or peptides including an essential amino acid, in the incubation products. Essential amino acids may include histidine, lysine, methionine, phenylalanine, threonine, taurine (sulfonic acid), isoleucine, and/or tryptophan, which may be present in the complete animal feed as a free amino acid or as part of a protein or peptide that is rich in the selected amino acid. At least one essential amino acid-rich peptide or protein may have at least 1% essential amino acid residues per total amino acid residues in the peptide or protein, at least 5% essential amino acid residues per total amino acid residues in the peptide or protein, or at least 10% essential amino acid residues per total amino acid residues in the protein. By feeding a diet balanced in nutrients to animals, maximum use is made of the nutritional content, requiring less feed to achieve comparable rates of growth, milk production, or a reduction in the nutrients present in the excreta reducing bioburden of the wastes.

A complete fish meal composition with an enhanced content of an essential amino acid, may have an essential amino acid content (including free essential amino acid and essential amino acid present in a protein or peptide) of at least 2.0 wt % relative to the weight of the crude protein and total amino acid content, and more suitably at least 5.0 wt % relative to the weight of the crude protein and total amino acid content. The complete fish meal composition includes other nutrients derived from microorganisms including but not limited to, fats, fatty acids, lipids such as phospholipid, vitamins, carbohydrates, sterols, enzymes, and trace minerals.

The complete fish meal composition may include complete feed form composition, concentrate form composition, blender form composition, and base form composition. If the composition is in the form of a complete feed, the percent nutrient level, where the nutrients are obtained from the microorganism in an incubation product, which may be about 10 to about 25 percent, more suitably about 14 to about 24 percent; whereas, if the composition is in the form of a concentrate, the nutrient level may be about 30 to about 50 percent, more suitably about 32 to about 48 percent. If the composition is in the form of a blender, the nutrient level in the composition may be about 20 to about 30 percent, more suitably about 24 to about 26 percent; and if the composition is in the form of a base mix, the nutrient level in the composition may be about 55 to about 65 percent. Unless otherwise stated herein, percentages are stated on a weight percent basis. If the PC is high in a single nutrient, e.g., Lys, it will be used as a supplement at a low rate; if it is balanced in amino acids and Vitamins, e.g., vitamin A and E, it will be a more complete feed and will be fed at a higher rate and supplemented with a low protein, low nutrient feed stock, like corn stover.

The fish meal composition may include a peptide or a crude protein fraction present in an incubation product having an essential amino acid content of at least about 2%. In embodiments, a peptide or crude protein fraction may have an essential amino acid content of at least about 3%, at least about 5%, at least about 10%, at least about 15%, at least about 20%, at least about 30%, at least about 40%, and in embodiments, at least about 50%. In embodiments, the peptide may be 100% essential amino acids. Commonly, the fish meal composition may include a peptide or crude protein fraction present in an incubation product having an essential amino acid content of up to about 10%. More commonly, the fish meal composition may include a peptide or a crude protein fraction present in an incubation product having an essential amino acid content of about 2-10%, 3.0-8.0%, or 4.0-6.0%.

The fish meal composition may include a peptide or a crude protein fraction present in an incubation product having a lysine content of at least about 2%. In embodiments, the peptide or crude protein fraction may have a lysine content of at least about 3%, at least about 5%, at least about 10%, at least about 15%, at least about 20%, at least about 30%, at least about 40%, and in embodiments, at least about 50%. Typically, the fish meal composition may include the peptide or crude protein fraction having a lysine content of up to about 10%. Where desired, the fish meal composition may include the peptide or a crude protein fraction having a lysine content of about 2-10%, 3.0-8.0%, or 4.0-6.0%.

The fish meal composition may include nutrients in the incubation product from about 1 g/Kg dry solids to 900 g/Kg dry solids. In embodiments, the nutrients in a fish meal composition may be present to at least about 2 g/Kg dry solids, 5 g/Kg dry solids, 10 g/Kg dry solids, 50 g/Kg dry solids, 100 g/Kg dry solids, 200 g/Kg dry solids, and about 300 g/Kg dry solids. In embodiments, the nutrients may be present to at least about 400 g/Kg dry solids, at least about 500 g/Kg dry solids, at least about 600 g/Kg dry solids, at least about 700 g/Kg dry solids, at least about 800 g/Kg dry solids and/or at least about 900 g/Kg dry solids.

The fish meal composition may include an essential amino acid or a peptide containing at least one essential amino acid present in an incubation product having a content of about 1 g/Kg dry solids to 900 g/Kg dry solids. In embodiments, the essential amino acid or a peptide containing at least one essential amino acid in a fish meal composition may be present to at least about 2 g/Kg dry solids, 5 g/Kg dry solids, 10 g/Kg dry solids, 50 g/Kg dry solids, 100 g/Kg dry solids, 200 g/Kg dry solids, and about 300 g/Kg dry solids. In embodiments, the essential amino acid or a peptide containing at least one essential amino acid may be present to at least about 400 g/Kg dry solids, at least about 500 g/Kg dry solids, at least about 600 g/Kg dry solids, at least about 700 g/Kg dry solids, at least about 800 g/Kg dry solids and/or at least about 900 g/Kg dry solids.

The complete fish meal composition may contain a nutrient enriched incubation product in the form of a biomass formed during incubation and at least one additional nutrient component. In another example, the fish meal composition contains a nutrient enriched incubation product that is dissolved and suspended from an incubation broth formed during incubation and at least one additional nutrient component. In a further embodiment, the fish meal composition has a crude protein fraction that includes at least one essential amino acid-rich protein. The fish meal composition may be formulated to deliver an improved balance of essential amino acids.

For compositions comprising DDGS, the complete composition form may contain one or more ingredients such as wheat middlings (“wheat midds”), corn, soybean meal, corn gluten meal, distiller's grains or distiller's grains with solubles, salt, macro-minerals, trace minerals and vitamins. Other potential ingredients may commonly include, but not be limited to sunflower meal, malt sprouts and soybean hulls. The blender form composition may contain wheat middlings, corn gluten meal, distiller's grains or distiller's grains with solubles, salt, macro-minerals, trace minerals and vitamins. Alternative ingredients would commonly include, but not be limited to, corn, soybean meal, sunflower meal, cottonseed meal, malt sprouts and soybean hulls. The base form composition may contain wheat middlings, corn gluten meal, and distiller's grains or distiller's grains with solubles. Alternative ingredients would commonly include, but are not limited to, soybean meal, sunflower meal, malt sprouts, macro-minerals, trace minerals and vitamins.

Highly unsaturated fatty acids (HUFAs) in microorganisms, when exposed to oxidizing conditions may be converted to less desirable unsaturated fatty acids or to saturated fatty acids. However, saturation of omega-3 HUFAs may be reduced or prevented by the introduction of synthetic antioxidants or naturally-occurring antioxidants, such as beta-carotene, vitamin E and vitamin C, into the feed. Synthetic antioxidants, such as BHT, BHA, TBHQ or ethoxyquin, or natural antioxidants such as tocopherols, may be incorporated into the food or feed products by adding them to the products, or they may be incorporated by in situ production in a suitable organism. The amount of antioxidants incorporated in this manner depends, for example, on subsequent use requirements, such as product formulation, packaging methods, and desired shelf life.

Incubation products or complete fish meal containing the incubation products of the present disclosure, may also be utilized as a nutritional supplement for human consumption if the process begins with human grade input materials, and human food quality standards are observed through out the process. Incubation product or the complete feed as disclosed herein is high in nutritional content. Nutrients such as, protein and fiber are associated with healthy diets. Recipes may be developed to utilize incubation product or the complete feed of the disclosure in foods such as cereal, crackers, pies, cookies, cakes, pizza crust, summer sausage, meat balls, shakes, and in any forms of edible food. Another choice may be to develop the incubation product or the complete feed of the disclosure into snacks or a snack bar, similar to a granola bar that could be easily eaten, convenient to distribute. A snack bar may include protein, fiber, germ, vitamins, minerals, from the grain, as well as nutraceuticals such as glucosamine. HUFAs, or co-factors, such as Vitamin Q-10.

The fish meal comprising the subject incubation products may be further supplemented with flavors. The choice of a particular flavor will depend on the animal to which the feed is provided. The flavors and aromas, both natural and artificial, may be used in making feeds more acceptable and palatable. These supplementations may blend well with all ingredients and may be available as a liquid or dry product form. Suitable flavors, attractants, and aromas to be supplemented in the animal feeds include but not limited to fish pheromones, fenugreek, banana, cherry, rosemary, cumin, carrot, peppermint oregano, vanilla, anise, plus rum, maple, caramel, citrus oils, ethyl butyrate, menthol, apple, cinnamon, any natural or artificial combinations thereof. The favors and aromas may be interchanged between different animals. Similarly, a variety of fruit flavors, artificial or natural may be added to food supplements comprising the subject incubation products for human consumption.

The shelf-life of the incubation product or the complete feed of the present disclosure may typically be longer than the shelf life of an incubation product that is deficient in the microorganism. The shelf-life may depend on factors such as, the moisture content of the product, how much air can flow through the feed mass, the environmental conditions and the use of preservatives. A preservative may be added to the complete feed to increase the shelf life to weeks and months. Other methods to increase shelf life include management similar to silage management such as mixing with other feeds and packing, covering with plastic or bagging. Cool conditions, preservatives and excluding air from the feed mass all extend shelf life of wet coproducts. The complete feed can be stored in bunkers or silo bags. Drying the wet incubation product or complete feed may also increase the product's shelf life and improve consistency and quality.

The complete feed of the present disclosure may be stored for long periods of time. The shelf life may be extended by ensiling, adding preservatives such as organic acids, or blending with other feeds such as soy hulls. Commodity bins or bulk storage sheds may be used for storing the complete feeds.

As used herein, “room temperature” is about 25° C. under standard pressure.

The following examples are illustrative and are not intended to limit the scope of the disclosed subject matter.

The following examples are intended to illustrate but not limit the invention.

### EXAMPLES

### Example 1

### DDGS Conversion with S. limacinum for EPA and Protein Production

Wet distiller's grains is converted into a DHA and protein enriched product as follows: pretreatment involves extrusion at 25% moisture content, 100° C., and screw speed of 200 rpm using a single screw extruder. These conditions result in 36% greater sugar release due to fiber disruption. The extruded material is then mixed with water in benchtop or pilot scale bioreactors to achieve a solid loading rate of 10-15%, the pH is adjusted to 5.5, and the slurry is autoclaved or pasteurized. After cooling, a cocktail of Novozyme enzymes (6% Cellic Ctek2 per gm glucan and 0.3% Cellic Htek2 per gm total solids) is added for 24 h saccharification at 50° C. and 150 rpm.

The temperature is then reduced to 25° C., the pH is adjusted to 7.0, and the slurry is inoculated with 2% (v/v) of a 24 h culture of S. limacinum. The slurry is agitated and aerated under optimal conditions until sugar utilization ceases (about 96-120 h). After 48 h CCS is added in a fed-batch mode to provide additional glycerol, as well as cause a nitrogen limitation to trigger additional DHA production. During incubation, samples are removed at 6-12 h intervals and assayed for: 1) carbohydrates and organic solvents using a Waters HPLC system, 2) microbial populations via plate or hemocytometer counts, and 3) DHA, EPA, and protein levels via AOAC methods.

### Example 2

### CCS conversion with P. irregulare for EPA and protein production

CCS is mixed with water to achieve a solid loading rate of 15-20% in benchtop or pilot scale bioreactors and the pH is adjusted to ˜7. Following autoclaving or pasteurization the temperature is set at 25° C. and the slurry is inoculated with 2% (v/v) of a 24 h culture of Pythium irregulare. The slurry is agitated and aerated under optimal conditions until maximum EPA levels are achieved (about 96-120 h). After 48 h, additional CCS is added in a fed-batch mode to provide glycerol and cause nitrogen limitation to trigger further EPA production. This also maximizes EPA and protein titers to minimize product recovery costs. During incubation, samples are be removed and analyzed as described above.

### Example 3

### Slurry Blending and Solids Recovery

The converted distiller's grains and CCS slurries are blended to achieve desired levels of DHA, EPA, and protein, and the omega-3 DDGS is recovered and dried. Following analysis, the solids are used to manufacture omega-3 DDGS based feeds that are tested in fish feeding trials. Supernatant is evaluated for re-use at the start of the process.

The omega-3 DDGS compositions are analyzed for nutritional competencies in view of yellow perch requirements. Samples are subjected to chemical analyses: proximate analysis, insoluble carbohydrates, amino acids, and fatty acids. This ensures that nutritional benchmarks are satisfied in treatment diets. Anti-nutritional concentrations (e.g., phytate) determined in input products are compared with omega-3 DDGS and provide a basis for future process modifications. Yellow perch feeding trials are performed under IACUC approval 11-070A.

Initially, a reference diet formulation is blended with each omega-3 DDGS product at a 70:30 ratio, each diet containing an inert marker. A minimum of 25 fish per test diet are fed to satiation twice daily for 10 days prior to the first fecal collection. Additional fecal collection is made every 10 days after initiation of feeding until adequate sample sizes are obtained. Fecal samples are collected from anesthetized fish (tricaine methanesulfonate) 12-16 h post-feeding by abdominal palpation stripping of distal digesta and then flash frozen. Sampled fish are allowed to recover in an oxygenated tank. Individual fecal collections from each tank are pooled to ensure adequate dry sample in each replicate for analysis. If needed, diets are rotated among the tanks during the digestibility trials so that three replicate fecal samples for each diet are obtained from fish in different tanks over time. Apparent digestibility coefficients (ADC) are determined by standard methods for each nutrient in the test diets.

The feeding performance trial uses complete diets formulated in accordance with known nutrient requirements for yellow perch (e.g., 45% protein, 9% lipid). Lot ingredient analyses are used in diet formulation to ensure that nutritional benchmarks are satisfied and to allow diet blends to be prepared on an isonitrogenous and isolipidic basis for direct performance comparisons between fish meal/oil control, DDGS and omega-3 DDGS treatment diets. DDGS and omega-3 DDGS amino acid (e.g., lysine) and fatty acid (e.g., HUFA n-3s) concentrations are examined for deficiencies in diet formulations and supplemented (e.g., flaxseed and fish oils) for comparison to formulations prepared without supplements (neo-synthesis potential). (Follow-up factorial studies incorporating incremental omega-3 DDGS inclusions are done with refined products). Mineral and vitamin premixes designed for plant-based diets are included at fixed minimum levels in all diets, including control, to ensure that micro-nutrient requirements are met across all diets. Macro-minerals are similarly supplemented as necessary. Pellets for feeding trials are produced using a single screw extruder (Extru-Tech Model 325, Sabetha, Kans.) with optimized extruder conditions (temperature, moisture, and speed).

Feed extrudates are analyzed according to approved procedures for dry matter at 105° C. for 3 h, crude protein using a LECO combustion analyzer (Method 990.03), ether extract (i.e., crude fat) (Method 920.39A), crude fiber (Method 978.10), and ash (Method 942.05). Amino acids are analyzed by HPLC with post column ninhydrin derivatization according to Method 982.30 E (a, b, c). Extracted lipids are esterified by boron trifluoride reagent (Method 969.33) and then methyl esters of fatty acids are separated by capillary GLC (Method 996.06). The gross energy of the diets was determined by bomb calorimetry.

Replication of four experimental units per dietary treatment are used in 105 d feeding trials (15-20 g fish; 20-25 fish/tank, Type I error probability <0.05). Trials are completed in 110-L circular tanks connected in parallel to a closed-loop recirculation system (solids sump, bioreactor, filters [100 μm bag, carbon and ultra-violet], and a centrifugal pump). Inline heat pumps are used to maintain optimal temperature. Water quality (e.g., dissolved oxygen, pH, temperature, ammonia and nitrite) is monitored daily. Flow rates (2 L/min) are monitored with fixed monometers and the dissolved oxygen concentration is maintained at saturation (rotary blower and diffusers).

Experimental diets are delivered twice daily. Growth performance is determined by total tank mass measurements at four week intervals; feed rations are adjusted in accordance with gains to allow satiation feeding and to reduce waste streams. Consumption is assessed biweekly from collections of uneaten pellets from individual tanks. Uneaten feed pellets are counted and dried to a constant weight to estimate conversion efficiency. Feed digestibilities (ADC protein and energy) are determined from fecal material manually stripped during the midpoint of each experiment or via necropsy from the lower intestinal tract at the conclusion. Survival (%), weight gain (g), specific growth rate, health indices, feed conversion, and protein and energy digestibilities are compared among treatments.

Measurements of whole body, total viscera, visceral fat, gonads, livers, and fillet weights are done at the end of the trial. Samples of fillets, visceral fat, and liver are pooled (n=5) to yield one sample per tank and stored in polyethylene bags at −20° C. Fillet samples are analyzed for proximate composition, while fatty acid profiles are determined for fillets, livers, and visceral fat using methods described earlier (and applied to duplicates). Color of fillets and livers are determined using a spectrophotometer (LabScan XE, Hunter Associates Laboratories, Inc., Reston, Va.), where: L refers to brightness/darkness, a refers to redness/greenness, and b refers to yellowness/blueness. Analysis of performance parameters and compositions among treatments are analyzed as a completely randomized design using individual tanks as an experimental unit. Analyses are performed using SAS v. 9.3 (Cary, N.C.). Post-hoc Duncan's multiple range tests compare treatment means with significance declared at P<0.05.

A preliminary mass balance is performed on the conversion process, and product yield is calculated. Process energy requirements are calculated based on a full scale model. This information is used to generate an economic model to project the processing costs.

### Example 4

### Effect of different concentrations of MgSO₄.7H₂O on DHA production by S. Limacinum

Various concentrations of MgSO₄.7H₂O (i.e., 0%, 0.061%, 0.122%, 0.244%, 0.305%, 0.488%) were added to 5% DDGS (2.5 g DDGS in 47.5 ml distilled water+2.5 ml of inoculum). The pH of the DDGS slurry was adjusted to 7 and sterilized prior to inoculation with 5% microalgae. The inoculated mixture was incubated at 25° C. for 5 days. After the incubation period, the material was freeze-dried and milled. The milled material was then assayed for protein and DHA content. Based on preliminary studies, optimal MgSO₄.7H₂O concentration should increase DHA values from 0.24% to between 1.5 to 3%, and protein content from 36% to between about >50 to about 55%.

### Example 5

### Plackett-Burman Design for Different Minerals and Micro-Nutrients Supplemented in DDGS Fermented by S. Limacinum

In order to further optimize DHA production by S. Limacinum, different minerals and micro-nutrients were used to supplement DDGS. The minerals and micro-nutrients investigated are listed in Table 2.

TABLE 2
Different minerals and micro-nutrients supplemented
to DDGS fermented by Schizochytrium

| Name | Units | Low | High |
|---|---|---|---|
| NaCl | g/l | 0 | 2 |
| MgSO₄•7H₂O | g/l | 0 | 2.44 |
| KCl | g/l | 0 | 0.6 |
| NaNO₃ | g/l | 0 | 1 |
| CaCl₂•2H₂O | g/l | 0 | 0.3 |
| KH₂PO₄ | g/l | 0 | 0.05 |
| Tris base | g/l | 0 | 1 |
| NH₄Cl | g/l | 0 | 0.027 |
| Vitamin B12 | ml/l | 0 | 1 |
| PI | ml/l | 0 | 10 |
| chelated iron | ml/l | 0 | 3 |
| ammonium acetate | g/l | 0 | 0.6 |
| pH | | 6 | 8 |

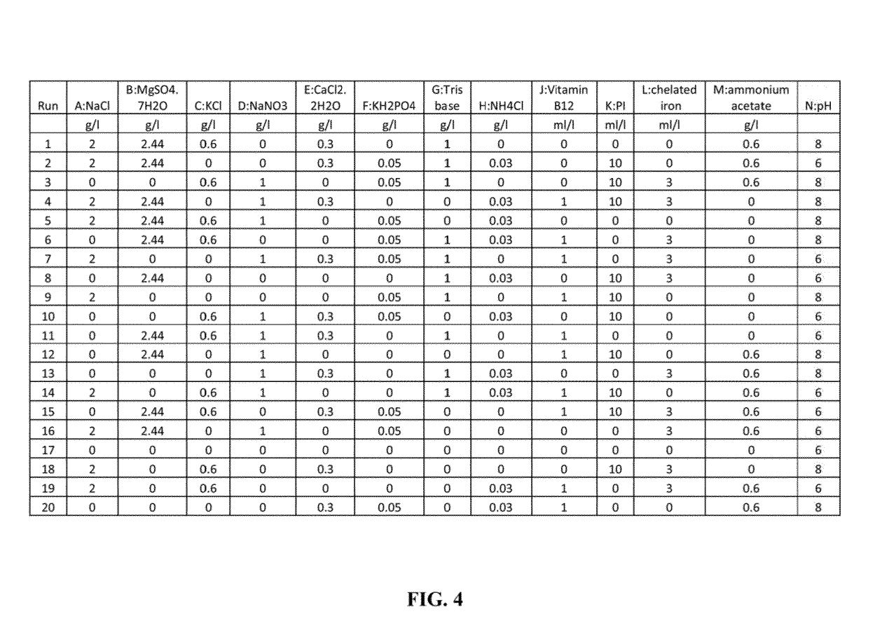

Design Expert software was used to generate the Plackett-Burman design for this trial. The different runs from the Plackett-Burman design are listed in the table in FIG. 4.

As above for the MgSO₄.7H₂O example, the substrate was 5% DDGS. For the 20 different runs, DDGS was supplemented with various concentrations of nutrients, A to M, added to the substrate, including varying the pH (N). The substrates were autoclaved at 121° C. for 20 min prior to inoculation. After cooling down the substrate, 5% Shizochytrium was used to inoculate the substrates, where subsequently, the supplemented DDGS samples were incubated at room temperature (25° C.) for five (5) days. After incubation, the samples were freeze-dried and milled for DHA analysis by GC. Based on preliminary studies, optimal mineral and micro-nutrient concentrations should increase DHA values from 0.24% to between 1.5 to 3%.

All of the references cited herein are incorporated by reference in their entireties.

From the above discussion, one skilled in the art can ascertain the essential characteristics of the invention, and without departing from the spirit and scope thereof, can make various changes and modifications of the embodiments to adapt to various uses and conditions. Thus, various modifications of the embodiments, in addition to those shown and described herein, will be apparent to those skilled in the art from the foregoing description. Such modifications are also intended to fall within the scope of the appended claims.

We claim herein:

1. A method of increasing the omega-3 fatty acid content of a non-animal based protein concentrate comprising:
a) optionally pre-treating a first cellulosic feedstock;
b) mixing the cellulosic feedstock with water and feeding the resulting mixture into a reactor;
c) sterilizing the mixture;
d) cooling the sterilized mixture and adding a consortium of saccharifying enzymes under conditions to form a hydrosylate;
e) cooling the hydrosylate and inoculating the hydrosylate with a biocatalyst that metabolizes sugars in the hydrosylate;
f) incubating the inoculated hydrosylate; and
g) optionally adding a second cellulosic feedstock to the inoculated hydrosylate and continuing incubation until the sugars are depleted to form a slurry,
wherein the slurry comprises protein, the biocatalyst and omega-3 fatty acids.

2. The method of claim 1, wherein the first cellulosic feedstock is DDGS.

3. The method of claim 1, wherein the second cellulosic feedstock is CCS.

4. The method of claim 1, wherein the protein content is between about 30 to about 55% on a dry matter basis.

5. The method of claim 1, wherein the omega-3 fatty acid is DHA.

6. The method of claim 5, wherein the DHA content is about 0.5 to about 3% on a dry matter basis.

7. The method of claim 1, wherein the biocatalyst is S. limacinum.

8. The method of claim 1, wherein the a second cellulosic feedstock is added after 48 hours incubation at step (f).

9. A method of increasing the omega-3 fatty acid content of a non-animal based protein concentrate comprising:
a) mixing a cellulosic feedstock with water and feeding the resulting mixture into a reactor;
b) sterilizing the mixture;
c) cooling the sterilized mixture and adding a consortium of saccharifying enzymes under conditions to form a hydrosylate;
d) cooling the hydrosylate and inoculating the hydrosylate with a biocatalyst that metabolizes sugars in the hydrosylate;
e) incubating the inoculated hydrosylate; and
f) optionally adding a second cellulosic feedstock to the inoculated hydrosylate and continuing incubation until the sugars are depleted to form a slurry,
wherein the slurry comprises protein, the biocatalyst and omega-3 fatty acids.

10. The method of claim 9, wherein the first cellulosic feedstock and the second cellulosic feedstock are CCS.

11. The method of claim 9, wherein the omega-3 fatty acid is EPA.

12. The method of claim 9, and the protein content is between about 30 to about 55% on a dry matter basis.

13. The method of claim 11, wherein the EPA content is about 0.8 to greater than about 3% on a dry matter basis.

14. The method of claim 9, wherein the biocatalyst is P. irregulare.

15. A protein concentrate produced by the method of claim 6, wherein the protein content is between about 30 to about 55% (dry matter basis).

16. A protein concentrate produced by the method of claim 13, wherein the protein content is between about 30 to about 55% (dry matter basis).

17. A protein concentrate containing a non-animal based protein enriched in omega-3 fatty acid content comprising a first slurry and a second slurry, wherein the first slurry is produced by:
a) optionally pre-treating a first cellulosic feedstock by extrusion;
b) mixing the first cellulosic feedstock with water and feeding the resulting first mixture into a first reactor;
c) sterilizing the first mixture;
d) cooling the sterilized first mixture and adding a first consortium of saccharifying enzymes under conditions to form a first hydrosylate;
e) cooling the first hydrosylate and inoculating the first hydrosylate with a first biocatalyst that metabolizes sugars in the first hydrosylate;
f) incubating the inoculated first hydrosylate; and
g) optionally adding a second cellulosic feedstock to the inoculated first hydrosylate and continuing incubation until the sugars are depleted to form said first slurry,
and wherein the second slurry is produced by:
h) mixing the second cellulosic feedstock with water and feeding the resulting second mixture into a second reactor;
i) sterilizing the second mixture;
j) cooling the second sterilized mixture and adding a second consortium of saccharifying enzymes under conditions to form a second hydrosylate;
k) cooling the second hydrosylate and inoculating the second hydrosylate with a second biocatalyst that metabolizes sugars in the second hydrosylate;
l) incubating the second inoculated hydrosylate; and
m) optionally adding additional second cellulosic feedstock to the second inoculated hydrosylate and continuing incubation until the sugars are depleted to form said second slurry,
wherein the concentrate is made by mixing the first and second slurries.

18. The composition of claim 17, which composition comprises protein, a biocatalyst, DHA and EPA.

19. The composition of claim 17, wherein said composition has a protein content of between about 30 to about 55% on a dry matter basis (dmb), a DHA content of between about 0.5 to about 3% dmb, and an EPA content of between about 0.8 to about 3% dmb.

20. A feed composition containing the composition of claim 17.
